(19) United States
(12) Patent Application Publication
(10) Pub. No.: US 2026/0228390 A1
(43) Pub. Date: Aug. 6, 2026

(54) Synchronizing and Updating Computational Models Across Different Nodes in a Computer System

(71) Applicant: International Business Machines Corporation, Armonk, NY (US)

(72) Inventors: Al Chakra, Apex, NC (US); Bo Chen Zhu, Xi'an (CN); Mai Zeng, Beijing (CN); Min Cheng, Beijing (CN); Jing Zhang, Poughkeepsie, NY (US); Peng Hui Jiang, Beijing (CN)

(21) Appl. No.: 19/045,853

(22) Filed: Feb. 5, 2025

(51) Int. Cl. G06F 30/27; G06F 111/02

(52) U.S. Cl. CPC G06F 30/27; G06F 2111/02

(57) ABSTRACT

A computer-implemented method for synchronizing computational models across different nodes in a computer system is presented. A processor set splits a computational model to generate a number of model sets for a number of nodes in the computer system. The processor set receives a request to update the computational model for the number of nodes in the computer system. The processor set collects a set of first increment data for the number of nodes. The processor set identifies a subset of sub-models based on the set of first increment data. The subset of sub-models is retrained to generate a number of updated models using the set of first increment data as training data. The processor set updates the computational model based on the number of updated models. The processor set synchronizes sub-models in different nodes based on the number of updated models.

### BACKGROUND

The disclosure relates generally to synchronizing and updating computational models across different nodes in a computer system.

An active-active architecture refers to a design where multiple nodes, servers, or data centers are actively processing requests and workloads simultaneously. Unlike traditional setups where only one node is active at a time, active-active architecture ensures that all components are fully operational and contribute to handling the workload at any given time. In other words, active-active architecture helps maximize uptime, optimize resource usage, and improve system performance.

In active-active architecture, model synchronization ensures consistency across multiple systems that are actively handling requests and workloads simultaneously. Synchronizing models involves maintaining the same version of a computational model across multiple nodes in a computer system and ensuring a consistent state when interacting with distributed systems. This feature is particularly important in machine learning or real-time systems where models need to operate seamlessly.

### SUMMARY

According to one illustrative embodiment, a computer-implemented method for synchronizing computational models across different nodes in a computer system is provided. A processor set splits a computational model to generate a number of model sets for a number of nodes in the computer system. Each model set from the number of model sets comprises a number of sub-models running on the number of nodes for performing a type of task. The processor set receives a request to update the computational model for the number of nodes in the computer system. The processor set collects a set of first increment data for the number of nodes. The set of first increment data is data that becomes available after the number of model sets are deployed on the number of nodes. The processor set identifies a subset of sub-models based on the set of first increment data. The subset of sub-models is retrained to generate a number of updated models using the set of first increment data as training data. The processor set updates the computational model based on the number of updated models. The processor set synchronizes sub-models in different nodes based on the number of updated models. According to other illustrative embodiments, a computer system, and a computer program product for synchronizing computational models across different nodes in a computer system are provided.

### BRIEF DESCRIPTION OF THE DRAWINGS

FIG. 1 is a pictorial representation of a computing environment in which illustrative embodiments may be implemented;

FIG. 2 is an illustration of a block diagram of a model management environment in accordance with an illustrative embodiment;

FIG. 3 is an illustration of a block diagram for nodes in a computer system in accordance with an illustrative embodiment;

FIG. 4 is a flowchart of a process for synchronizing computational models across different nodes in accordance with an illustrative embodiment;

FIG. 5 is a flowchart of a process for synchronizing sub-models in different nodes based on the number of updated models in accordance with an illustrative embodiment;

FIG. 6 is a flowchart of a process for retraining the second number of sub-models for the second node using the training dataset in accordance with an illustrative embodiment;

FIG. 7 is a flowchart of a process for updating sub-models in the second node based on the set of feature data in accordance with an illustrative embodiment;

FIG. 8 is a flowchart of a process for updating the computational model based on the number of updated models in accordance with an illustrative embodiment; and

FIG. 9 is a block diagram of a data processing system in accordance with an illustrative embodiment.

### DETAILED DESCRIPTION

A computer implemented method synchronizes computational models across different nodes in a computer system. A processor set splits a computational model to generate a number of model sets for a number of nodes in the computer system. Each model set from the number of model sets comprises a number of sub-models running on the number of nodes for performing a type of task. The processor set receives a request to update the computational model for the number of nodes in the computer system. The processor set collects a set of first increment data for the number of nodes. The set of first increment data is data that becomes available after the number of model sets are deployed on the number of nodes. The processor set identifies a subset of sub-models based on the set of first increment data. The subset of sub-models is retrained to generate a number of updated models using the set of first increment data as training data. The processor set updates the computational model based on the number of updated models. The processor set synchronizes sub-models in different nodes based on the number of updated models. As a result, the illustrative embodiments provide a technical effect of synchronizing computational models across nodes in the computer system without transmitting extra data across the computer system.

In the illustrative embodiments, as part of synchronizing sub-models in different nodes based on the number of updated models, the processor set receives a set of second increment data for a first node. The set of second increment data is selected during the update of the computational model. The processor set compares functions for the subset of sub-models and functions for the number of updated models to generate high weighted data for the subset of sub-models. The processor set generates a set of feature data by clustering high weighted data for the subset of sub-models. The processor set sends the set of feature data from the first node to a second node. The processor set updates sub-models in the second node based on the set of feature data. As a result, the illustrative embodiments provide a technical effect of using the set of feature data to represent all updated data for synchronizing different nodes in the computer system such that extra data transmission among nodes in the computer system can be avoided.

In the illustrative embodiments, as part of updating sub-models in the second node based on the set of feature data, the processor set receives a set of second increment data for a first node. The processor set identifies a second number of sub-models for the second node based on the set of feature data received from the first node. The processor set generates a training dataset by randomly initializing an expanded parameter matrix for each data pair in the set of feature data. The processor set retrains the second number of sub-models for the second node using the training dataset. As a result, the illustrative embodiments provide a technical effect of retraining models of a second node in the computer system using the set of feature data from the first node, thereby synchronizing models in different nodes such that extra data transmission among nodes in the computer system can be avoided.

In the illustrative embodiments, the high weighted data comprises the largest weight for a number of parameters in functions for the subset of sub-models and functions for the number of updated models. As a result, the illustrative embodiments provide a technical effect of using the largest weight for parameters in functions for sub-models that need to be updated to generate the set of feature data such that extra data transmission among nodes in the computer system can be avoided.

In the illustrative embodiments, as part of updating sub-models in the second node based on the set of feature data, the processor set identifies a second number of sub-models for the second node based on the set of feature data received from the first node. The processor set receives performance data for the second node. The processor set determines a number of adjusted parameters by comparing the performance data for the second node and the set of feature data received from the first node. The processor set retrains the second number of sub-models based on an expanded parameter matrix generated using the number of adjusted parameters. As a result, the illustrative embodiments provide a technical effect of retraining models of a second node in the computer system using the set of feature data from the first node by directly comparing data to determine parameters that need to be updated, thereby synchronizing models in different nodes such that extra data transmission among nodes in the computer system can be avoided.

In the illustrative embodiments, as part of updating the computational model based on the number of updated models, the processor set compares the number of updated models with existing sub-models for the computational model. The processor set merges models from the number of updated models and the existing sub-models for the computational model that have the same function expressions. As a result, the illustrative embodiments provide a technical effect of managing duplicate models after updates such that computer resources can be efficiently utilized.

In the illustrative embodiments, the comparison between the number of updated models with existing sub-models for the computational model is performed by analyzing transactions for the computational model, the rate of each transaction for the computational model, and the system cost for the computational model. As a result, the illustrative embodiments provide a technical effect of using the most relevant metrics for comparing the number of updated models with existing sub-models for efficiently identifying duplicated models.

A computer system comprises a processor set, a set of one or more computer-readable storage media, and program instructions, stored in the set of one or more computer-readable storage media, to cause the processor set to perform the following computer operations. The processor set splits a computational model to generate a number of model sets for a number of nodes in the computer system. Each model set from the number of model sets comprises a number of sub-models running on the number of nodes for performing a type of task. The processor set receives a request to update the computational model for the number of nodes in the computer system. The processor set collects a set of first increment data for the number of nodes. The set of first increment data is data that becomes available after the number of model sets are deployed on the number of nodes. The processor set identifies a subset of sub-models based on the set of first increment data. The subset of sub-models is retrained to generate a number of updated models using the set of first increment data as training data. The processor set updates the computational model based on the number of updated models. The processor set synchronizes sub-models in different nodes based on the number of updated models. As a result, the illustrative embodiments provide a technical effect of synchronizing computational models across nodes in the computer system without transmitting extra data across the computer system.

In the illustrative embodiments, as part of synchronizing sub-models in different nodes based on the number of updated models, the processor set further executes the program instructions to receive a set of second increment data for a first node. The set of second increment data is selected during the update of the computational model. The processor set further executes the program instructions to compare functions for the subset of sub-models and functions for the number of updated models to generate high weighted data for the subset of sub-models. The processor set further executes the program instructions to generate a set of feature data by clustering high weighted data for the subset of sub-models. The processor set further executes the program instructions to send the set of feature data from the first node to a second node. The processor set further executes the program instructions to update sub-models in the second node based on the set of feature data. As a result, the illustrative embodiments provide a technical effect of using the set of feature data to represent all updated data for synchronizing different nodes in the computer system such that extra data transmission among nodes in the computer system can be avoided.

In the illustrative embodiments, as part of updating sub-models in the second node based on the set of feature data, the processor set further executes the program instructions to receive a set of second increment data for a first node. The processor set further executes the program instructions to identify a second number of sub-models for the second node based on the set of feature data received from the first node. The processor set further executes the program instructions to generate a training dataset by randomly initializing an expanded parameter matrix for each data pair in the set of feature data. The processor set further executes the program instructions to retrain the second number of sub-models for the second node using the training dataset. As a result, the illustrative embodiments provide a technical effect of retraining models of a second node in the computer system using the set of feature data from the first node, thereby synchronizing models in different nodes such that extra data transmission among nodes in the computer system can be avoided.

In the illustrative embodiments, the high weighted data comprises the largest weight for a number of parameters in functions for the subset of sub-models and functions for the number of updated models. As a result, the illustrative embodiments provide a technical effect of using the largest weight for parameters in functions for sub-models that need to be updated to generate the set of feature data such that extra data transmission among nodes in the computer system can be avoided.

In the illustrative embodiments, as part of updating sub-models in the second node based on the set of feature data, the processor set further executes the program instructions to identify a second number of sub-models for the second node based on the set of feature data received from the first node. The processor set further executes the program instructions to receive performance data for the second node. The processor set further executes the program instructions to determine a number of adjusted parameters by comparing the performance data for the second node and the set of feature data received from the first node. The processor set further executes the program instructions to retrain the second number of sub-models based on an expanded parameter matrix generated using the number of adjusted parameters. As a result, the illustrative embodiments provide a technical effect of retraining models of a second node in the computer system using the set of feature data from the first node by directly comparing data to determine parameters that need to be updated, thereby synchronizing models in different nodes such that extra data transmission among nodes in the computer system can be avoided.

In the illustrative embodiments, as part of updating the computational model based on the number of updated models, the processor set further executes the program instructions to compare the number of updated models with existing sub-models for the computational model. The processor set further executes the program instructions to merge models from the number of updated models and the existing sub-models for the computational model that have the same function expressions. As a result, the illustrative embodiments provide a technical effect of managing duplicate models after updates such that computer resources can be efficiently utilized.

In the illustrative embodiments, the comparison between the number of updated models with existing sub-models for the computational model is performed by analyzing transactions for the computational model, the rate of each transaction for the computational model, and the system cost for the computational model. As a result, the illustrative embodiments provide a technical effect of using the most relevant metrics for comparing the number of updated models with existing sub-models for efficiently identifying duplicated models.

In the illustrative embodiments, a computer program product synchronizes computational models across different nodes in a computer system. The computer program product comprises a set of one or more computer-readable storage media and program instructions, stored in the set of one or more computer-readable storage media, for causing a processor set to perform the following computer operations. The program instructions are executable by a computer system to split a computational model to generate a number of model sets for a number of nodes in the computer system. Each model set from the number of model sets comprises a number of sub-models running on the number of nodes for performing a type of task. The program instructions are executable by the computer system to cause the computer system to receive a request to update the computational model for the number of nodes in the computer system. The program instructions are executable by the computer system to cause the computer system to collect a set of first increment data for the number of nodes. The set of first increment data is data that becomes available after the number of model sets are deployed on the number of nodes. The program instructions are executable by the computer system to cause the computer system to identify a subset of sub-models based on the set of first increment data. The subset of sub-models is retrained to generate a number of updated models using the set of first increment data as training data. The program instructions are executable by the computer system to cause the computer system to update the computational model based on the updated models. The program instructions are executable by the computer system to cause the computer system to synchronize sub-models in different nodes based on the updated models. As a result, the illustrative embodiments provide a technical effect of synchronizing computational models across nodes in the computer system without transmitting extra data across the computer system.

In the illustrative embodiments, as part of synchronizing sub-models in different nodes based on the updated models, the program instructions are executable by the computer system to cause the computer system to receive a set of second increment data for a first node. The set of second increment data is selected during the update of the computational model. The program instructions are executable by the computer system to cause the computer system to compare functions for the subset of sub-models and functions for the number of updated models to generate high weighted data for the subset of sub-models. The program instructions are executable by the computer system to cause the computer system to generate a set of feature data by clustering high weighted data for the subset of sub-models. The program instructions are executable by the computer system to cause the computer system to send the set of feature data from the first node to a second node. The program instructions are executable by the computer system to cause the computer system to update sub-models in the second node based on the set of feature data. As a result, the illustrative embodiments provide a technical effect of using the set of feature data to represent all updated data for synchronizing different nodes in the computer system such that extra data transmission among nodes in the computer system can be avoided.

In the illustrative embodiments, as part of updating sub-models in the second node based on the set of feature data, the program instructions are executable by the computer system to cause the computer system to receive a set of second increment data for a first node. The program instructions are executable by the computer system to cause the computer system to identify a second number of sub-models for the second node based on the set of feature data received from the first node. The program instructions are executable by the computer system to cause the computer system to generate a training dataset by randomly initializing an expanded parameter matrix for each data pair in the set of feature data. The program instructions are executable by the computer system to cause the computer system to retrain the second number of sub-models for the second node using the training dataset. As a result, the illustrative embodiments provide a technical effect of retraining models of a second node in the computer system using the set of feature data from the first node, thereby synchronizing models in different nodes such that extra data transmission among nodes in the computer system can be avoided.

In the illustrative embodiments, the high weighted data comprises the largest weight for a number of parameters in functions for the subset of sub-models and functions for the number of updated models. As a result, the illustrative embodiments provide a technical effect of using the largest weight for parameters in functions for sub-models that need to be updated to generate the set of feature data such that extra data transmission among nodes in the computer system can be avoided.

In the illustrative embodiments, as part of updating sub-models in the second node based on the set of feature data, the program instructions are executable by the computer system to cause the computer system to identify a second number of sub-models for the second node based on the set of feature data received from the first node. The program instructions are executable by the computer system to cause the computer system to receive performance data for the second node. The program instructions are executable by the computer system to cause the computer system to determine a number of adjusted parameters by comparing the performance data for the second node and the set of feature data received from the first node. The program instructions are executable by the computer system to cause the computer system to retrain the second number of sub-models based on an expand parameter matrix generated using the number of adjusted parameters. As a result, the illustrative embodiments provide a technical effect of retraining models of a second node in the computer system using the set of feature data from the first node by directly comparing data to determine parameters that need to be updated, thereby synchronizing models in different nodes such that extra data transmission among nodes in the computer system can be avoided.

In the illustrative embodiments, as part of updating the computational model based on the updated models, the program instructions are executable by the computer system to cause the computer system to compare the number of updated models with existing sub-models for the computational model. The program instructions are executable by the computer system to cause the computer system to merge models from the number of updated models and the existing sub-models for the computational model that have the same function expressions. As a result, the illustrative embodiments provide a technical effect of managing duplicate models after updates such that computer resources can be efficiently utilized.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

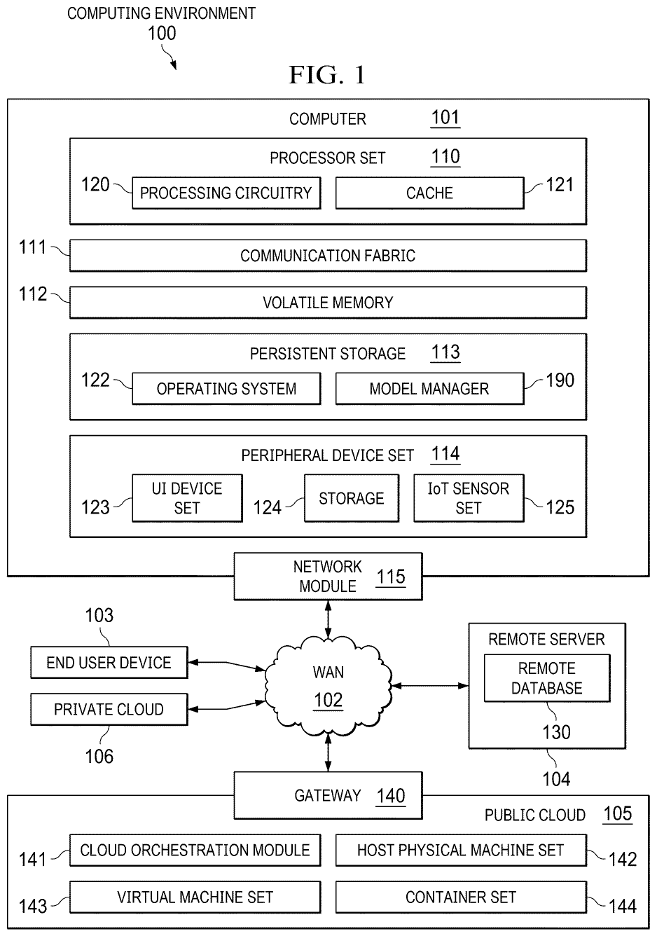

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as model manager 190. In addition to model manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in model manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in model manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that different nodes in a computer system may be located in different geographic locations. In this case, it is difficult to transfer data between nodes in the system therefore the nodes in the computer system can only rely on local incremental data to update models within each node.

The illustrative embodiments also recognize and take into account that the incremental data is different across different nodes due to the differences among nodes in a computer system such as hardware and network. In addition, the illustrative embodiments also recognize and take into account that a computational model for a computer system that includes multiple nodes is not accurate if the computational model is updated using local data on each node in the computer system.

The illustrative embodiments also recognize and take into account that extra data transmission is required when updating a computational model for a computer system that include multiple nodes.

Thus, illustrative embodiments of the present invention provide a computer implemented method, computer system, and computer program product for synchronizing computational models across different nodes in a computer system. A processor set splits a computational model to generate a number of model sets for a number of nodes in the computer system. Each model set from the number of model sets comprises a number of sub-models running on the number of nodes for performing a type of task. The processor set receives a request to update the computational model for the number of nodes in the computer system. The processor set collects a set of first increment data for the number of nodes. The set of first increment data is data that becomes available after the number of model sets are deployed on the number of nodes. The processor set identifies a subset of sub-models based on the set of first increment data. The subset of sub-models is retrained to generate a number of updated models using the set of first increment data as training data. The processor set updates the computational model based on the number of updated models. The processor set synchronizes sub-models in different nodes based on the number of updated models.

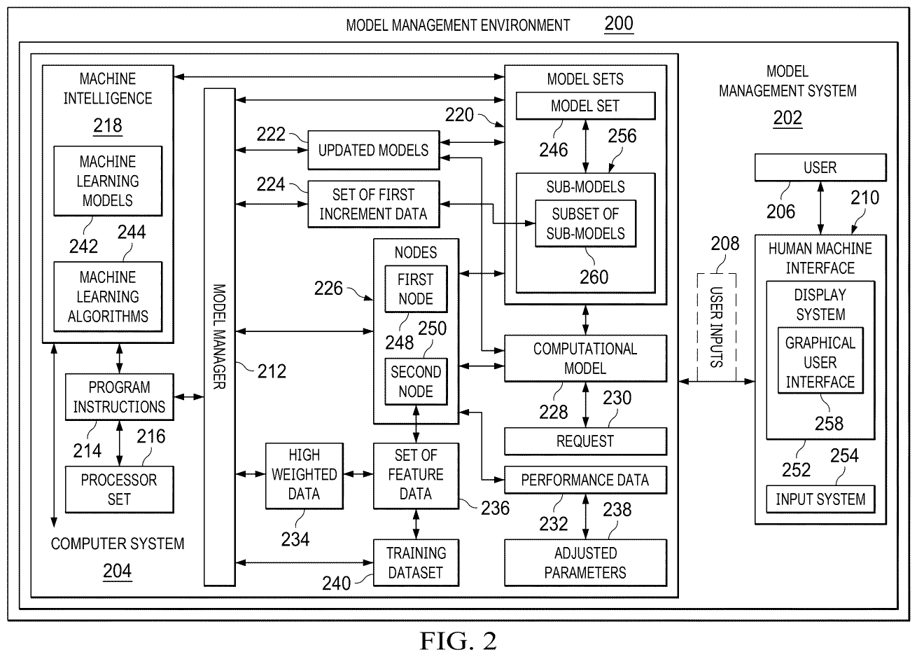

With reference now to FIG. 2, an illustration of a block diagram of a model management environment is depicted in accordance with an illustrative embodiment. In this illustrative example, model management environment 200 includes components that can be implemented in hardware such as the hardware shown in computing environment 100 in FIG. 1.

In this illustrative example, model management system 202 in model management environment 200 can be used to update and synchronize computational model 228 for nodes 226 within computer system 204. In this illustrative example, computational model 228 is a mathematical or algorithmic framework used to simulate, analyze and predict behavior of complex systems or processes. For example, computational model 228 can be a performance model in an active-active architecture that evaluates and optimizes system performance for computer system 204.

In this illustrative example, model management system 202 includes computer system 204 which includes model manager 212. Model manager 212 is located in computer system 204. Model manager 212 may be implemented using model manager 190 in FIG. 1.

Model manager 212 can be implemented in software, hardware, firmware, or a combination thereof. When software is used, the operations performed by model manager 212 can be implemented in program instructions configured to run on hardware, such as a processor unit. When firmware is used, the operations performed by model manager 212 can be implemented in program instructions and data and stored in persistent memory to run on a processor unit. When hardware is employed, the hardware can include circuits that operate to perform the operations in model manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 and implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning, unsupervised machine learning, or semi-supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer for updating and synchronizing computational model 228 for nodes 226 in computer system 204.

Machine learning models 242 involves using machine learning algorithms 244 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 244 can include supervised machine learning algorithms and unsupervised machine learning algorithms. Supervised machine learning can train machine learning models 242 using data containing both the inputs and desired outputs. Examples of machine learning algorithms 244 include Gradient Boosting algorithm, Autogressive Integrated Moving AVERAGE (ARIMA), XGBoost, K-means clustering, and Random Forest algorithm.

In this illustrative example, machine learning models 242 can be retrained or updated using new data or outputs generated by machine learning models 242 such that parameters in machine learning algorithms 244 selected for machine learning models 242 can be adjusted to improve accuracy and efficiency of machine learning models 242. In this illustrative example, computational model 228 can be a model selected from a machine learning models 242.

As depicted, computer system 204 includes nodes 226 for processing workloads and tasks. In this illustrative example, nodes 226 are a physical or virtual device, server, or process that is part of computer system 204 that is capable of sending, receiving, processing, or storing data. In this illustrative example, each node in nodes 226 has a copy of computational model 228.

In this illustrative example, computational model 228 can be split into model sets 220. Each model set from model sets 220 includes sub-models for processing a type of workloads and tasks. For example, model set 246 can include sub-models 256 that are all configured to perform a particular type of task or workload. In this illustrative example, computational model 228 optimizes efficiency and performance for nodes 226 to process workloads and tasks simultaneously. For example, computational model 228 can be used to optimize efficiency and performance for first node 248 and second node 250 to process workloads and tasks simultaneously.

In this illustrative example, computational model 228 can be initially trained using performance records from single or combined workloads that are processed by nodes 226. In this example, the initial model for computational model 228 can be expressed as:

$$M = F ( t , r , p ) \qquad ( 1 )$$

Where t is the transactions that include a number of program operations, r is the rate of each transaction, and p is the system cost metric.

The initial model for computational model 228 can be analyzed to retrieve key factors for splitting computational model 228 into sub-models that make up model sets 220. In this illustrative example, the initial model for computational model 228 can be split into sub-models that are distributed to all nodes in nodes 226. In this illustrative example, model manager 212 analyzes sub-models for computational model 228 to check if any overlapping sub-models exist and merges overlapping sub-models if any overlapping sub-models can be identified. The sub-models for computational model 228 can be expressed as:

$${M}_{i} = {f}_{i} ( t , r , p ) \qquad ( 2 )$$

$$( {M}_{i} ∈ M , {f}_{i} ∈ F , t ∈ {T}_{i} \{ {t}_{i 1} , … , {t}_{i n} \} , r ∈ {R}_{i} \{ {r}_{i 1} , … , {r}_{i n} \} )$$

As depicted, model manager 212 can perform an update of computational model 228 across nodes 226. In this illustrative example, model manager 212 can initiate updates and synchronization upon receiving request 230 for updating computational model 228. In this illustrative example, request 230 can be a request automatically generated by model management system 202 upon detecting a number of pre-defined rules or thresholds are reached, or a request is generated manually through user-input.

In this illustrative example, model manager 212 collects set of first increment data 224 from nodes 226 or a portion of nodes 226. Set of first increment data 224 are data that have been newly generated or modified since the last synchronization or update for computational model 228. In this illustrative example, model manager 212 identifies subset of sub-models 260 based on set of first increment data 224. In other words, subset of sub-models 260 are sub-models in sub-models 256 that need to be updated or synchronized because they are associated with new data and modified data.

In this illustrative example, set of first increment data 224 can be selected as I={t_{I},r_{I},p_{I}}, and for Mᵢ=fᵢ(t,r,p) (Mᵢ∈M, fᵢ∈F, t∈Tᵢ{tᵢ₁, . . . , tᵢₙ}, r∈Rᵢ{rᵢ₁, . . . , rᵢₙ}, If t_{I}∈Tᵢ, r_{I}∈Rᵢ, then Mᵢ can be selected as part of subset of sub-models 260 for updates.

In this illustrative example, model manager 212 uses machine intelligence 218 to retrain subset of sub-models 260 using set of first increment data 224. As a result, updated models 222 are generated by model manager 212 after retraining. In this example, model manager 212 can replace subset of sub-models 260 using updated models 222. In addition, model manager 212 can analyze updated models 222 by checking if updated models 222 overlaps with any of the existing sub-models for computational model 228, and merges overlapping models if any overlapped models can be identified. In this illustrative example, the analysis for updated models 222 can include function analysis, transaction analysis, and rate analysis for each sub-model in updated models 222. In this example, updated models 222 can be directly distributed to nodes 226 for replacing subset of sub-models 260 if no overlapping sub-models can be identified.

In an alternative illustrative example, model manager 212 can also be used to synchronize sub-models across nodes in nodes 226 by using nodes that are already updated with updated models 222. For example, model manager 212 can synchronize second node 250 with first node 248, which is already updated. As depicted, synchronization of nodes 226 is particularly helpful since nodes in nodes 226 have different hardware, network, and common workloads.

In this illustrative example, a set of second increment data is collected during update of sub-models for first node 248. During the update, model manager 212 compares functions for subset of sub-models 260 and updated models 222 to generate high weighted data 234 based on the set of second increment data. For example, a sub-model from subset of sub-models 260 can be:

$$f ( t , r , p ) = {\sum }_{m = 1}^{k} {w}_{fm} {p}_{m} + {\sum }_{m = 1}^{k} {w}_{rm} {r}_{m} + {\sum }_{{m = 1}_{{n = 1}_{j = 1}}}^{k} {w}_{mnj} {p}_{m}^{n} {r}_{m}^{j} \qquad ( 3 )$$

In addition, the updated model from updated models 222 that corresponds to the sub-model from subset of sub-models 260 mentioned above can be:

$${f}^{u} ( t , r , p ) = {\sum }_{m = 1}^{k} {w}_{tm}^{u} {p}_{m} + {\sum }_{m = 1}^{k} {w}_{rm}^{u} {r}_{m} + {\sum }_{{m = 1}_{{n = 1}_{j = 1}}}^{k} {w}_{mnj}^{u} {p}_{m}^{n} {r}_{m}^{j} \qquad ( 4 )$$

The two weight sets for the function (3) and function (4) are W{w} and W^{u}{w^{u}}. In this illustrative example, model manager 212 compares the weight sets to generate high weighted data 234 by including the biggest weight for both transaction and rate from the weight sets. High weighted data 234 includes data for all sub-models from subset of sub-models 260. In this example, high weighted data 234 can be determined by:

$${max}_{m ∈ l} ( {w}_{tm}^{u} + {w}_{r m}^{u} + {w}_{m n j}^{u} ) \qquad ( 5 )$$

In this illustrative example, model manager 212 performs grouping techniques for each sub-model based on data characteristics of high weighted data 234 to format high weighted data 234. As a result, a high weighted data group

$${G}_{i} \{ {G}_{i}^{1} , … , {G}_{i}^{k} \}$$

is generated for each sub model Mᵢ. In this illustrative example, model manager 212 clusters data from the core vector and confidence variance to generate data pair (c,v) for each high weighted data group. As a result, data pairs can be formatted to generate feature data groups

$${G}_{F i} = \{ ( {c}_{i}^{1} , {v}_{i}^{1} ) , … , ( {c}_{i}^{k} , {v}_{i}^{k} ) \}$$

as set of feature data 236.

Model manager 212 can send set of feature data 236 from first node 248 to second node 250 through packets. In this illustrative example, model manager 212 can format the packets to include model headers to indicate which sub-models require synchronization. In this illustrative example, the packet can be small and easy to transfer between nodes since it only includes one record for each sub-model.

In this illustrative example, model manager 212 performs model synchronization for second node 250 by extracting information in set of feature data 236 received from first node 248. In this illustrative example, sub-models in second node 250 that require synchronization can be identified through model headers in packets. In this illustrative example, an expand parameter matrix is randomly initialized for each data pair (c,v) from

$${G}_{F i} = \{ ( {c}_{i}^{1} , {v}_{i}^{1} ) , … , ( {c}_{i}^{k} , {v}_{i}^{k} ) \}$$

of set of feature data 236. In this example, training dataset 240 can be generated using an expand parameter matrix determined based on set of feature data 236. Training dataset 240 can be expressed as:

$$E = [ {e}_{1} , {e}_{2} , … ] , S . T . ‖ cE - c ‖ \leq v \& . ∀ ( {c}^{′} , {v}^{′} ) , ‖ cE - {c}^{′} ‖ > {v}^{′} \qquad ( 5 )$$

where e is the expanded parameter vector.

In this illustrative example, model manager 212 can use training dataset 240 to retrain sub-models in second node 250 that need to be synchronized. In other words, subset of sub-models 260 from the copy of computational model 228 on second node 250 can be updated or synchronized directly utilizing set of feature data 236 received from first node 248.

In an alternative example, model manager 212 can collect performance data 232 for sub-models for second node 250 as second node 250 processes tasks or workloads. In this illustrative example, performance data 232 is information that measures how well an individual sub-model within a node performs its specific tasks or functions. In this example, model manager 212 determines whether sub-models in second node 250 needs update or synchronization based on performance data 232. If an update is needed, model manager 212 uses grouping techniques to divide performance data 232 into different groups and generate core and variance pairs for each group. In this example, core and variance pairs for each group can be expressed as

$$( {c}_{i}^{r} , {v}_{i}^{r} ) .$$

In this illustrative example, model manager 212 compares core

$$“ {c}_{i}^{r} ”$$

from core and variance pairs for performance data 232 and core “cᵢ” for set of feature data 236 to get adjusted parameter bᵢ, where

$${c}_{i}^{r} = {c}_{i} + {b}_{i} .$$

In a similar fashion, model manager 212 compares variance

$$“ {v}_{i}^{r} ”$$

from core and variance pairs for performance data 232 and variance “vᵢ” for set of feature data 236 to get adjusted parameter aᵢ, where

$${v}_{i}^{r} = {a}_{i} {v}_{i} .$$

Adjusted parameter aᵢ and adjusted parameter bᵢ can be used for generating adjusted parameters 238. In this example, adjusted parameters 238 can be added to expand parameters such as an expand parameter matrix shown in equation (5). In this illustrative example, the expand parameter matrix with adjusted parameters 238 can be expressed as:

$$E = [ {e}_{1} + b , {e}_{2} + b , … ] , S . T . ‖ {cE}^{r} - c ‖ \leq av \& . \qquad ( 6 )$$

$$∀ ( {c}^{′} , {v}^{′} ) , ‖ {cE}^{r} - {c}^{′} ‖ > {a}^{′} {v}^{′}$$

As a result, the expand parameter matrix with adjusted parameters 238 as shown in equation (6) can be used to retrain sub-models for second node 250.

In this illustrative example, user 206 can interact with computer system 204 through user inputs to computer system 204. For example, computer system 204 can receive user inputs 208 that specify request 230 for updating and synchronizing computational model 228.

In this illustrative example, user inputs 208 can be generated by user 206 using human machine interface (HMI) 210. As depicted, human machine interface 210 includes display system 252 and input system 254. Display system 252 is a physical hardware system and includes one or more display devices on which graphical user interface 258 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 258 through user inputs 208 generated by input system 254. Input system 254 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view high weighted data 234, set of feature data 236, performance data 232, and adjusted parameters 238.

In one illustrative example, one or more solutions are present that overcome a problem with updating and synchronizing computational models across different nodes in a computer system. As a result, one or more technical solutions may provide an ability to increase the efficiency and performance in computer system 204 by efficiently synchronizing and updating nodes across a computer system without transmitting a large amount of data that causes network delays and system overheads.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 212 in computer system 204 enables synchronization and updates of computational models for nodes across a computer system in an efficient manner. In particular, model manager 212 transforms computer system 204 into a special purpose computer system as compared to currently available general computer systems that do not have model manager 212.

In the illustrative example, the use of model manager 212 in computer system 204 integrates processes into a practical application for synchronizing and updating of computational models for nodes across a computer system. In other words, model manager 212 in computer system 204 is directed to a practical application of processes integrated into model manager 212 in computer system 204 that supports synchronization and updates of computational models for nodes across a computer system. In this illustrative example, model manager 212 can efficiently help computer system 204 to increase computer performance and avoid wasting computing resources because synchronization and updates of computational models using the above mentioned method require minimal data transmission between nodes. Such a method is especially helpful when workloads and tasks are switched from one node to another in active-active architecture.

The illustration of model management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, synchronization of computational model 228 across nodes 226 can be performed for other nodes in nodes 226 simultaneously using first node 248.

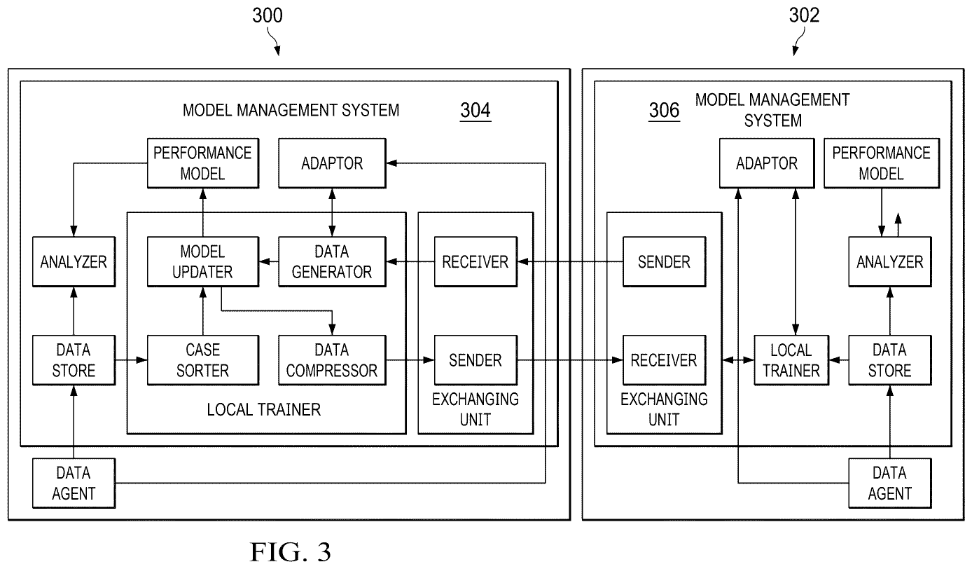

With reference now to FIG. 3, an illustration of a block diagram for nodes in a computer system is shown in accordance with an illustrative embodiment. In this illustrative example, model management system 304 and model management system 306 can be implemented using model manager 212 in FIG. 2.

In FIG. 3, the initial model training for the performance model shown in model management system 304 and model management system 306 can be performed using the method described in FIG. 2. In this illustrative example, the performance model will be distributed to each node such as node 300 and node 302 after initial model training. In this example, node 300 and node 302 can be examples of first node 248 and second node 250 in FIG. 2.

In node 300 and node 302, data agents can be used for collecting incremental data that is generated from data stores when a model update is required. In this illustrative example, data agents transmit the incremental data from data stores to case sorters for identifying sub-models from the performance model that require updates. After identification of the sub-models that require updates, model updaters update the identified sub-models by retraining the identified sub-models using collected incremental data. As a result, the identified sub-models in the performance model can be replaced with retrained models for improved efficiency.

In this illustrative example, model updaters in node 300 and node 302 can also generate high-weighted data during the update of a sub-model. In this illustrative example, data compressors in node 300 and node 302 can be used to format the high-weighted data as sub-groups and then generate feature data that can be sent to other nodes through senders. In this illustrative example, senders will send the feature data to receivers in other nodes.

In this illustrative example, data generators can generate training data by expanding the feature data received from senders in other nodes. As a result, model updaters will retrain the related sub-models using the training data to synchronize performance models across nodes.

In an alternative example, data generators can also provide performance data of nodes to adaptors for updating performance models. In this illustrative example, adaptors can update and synchronize performance models by adjusting parameters for functions of sub-models within the performance models based on the performance data and the feature data.

The illustration of block diagrams in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, model management system 304 and model management system 306 can include more components that can be configured to perform functions as described above.

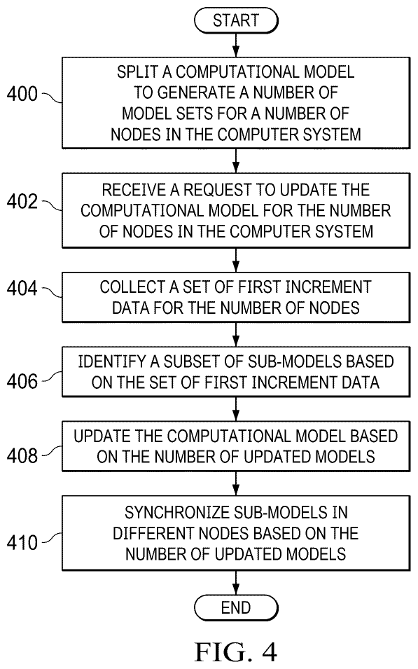

With reference now to FIG. 4, a flowchart illustrating a process for synchronizing computational models across different nodes in a computer system is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in model manager 212 in computer system 204 in FIG. 2.

The process begins by splitting a computational model to generate a number of model sets for a number of nodes in the computer system (step 400). In step 400, each model set from the number of model sets comprises a number of sub-models running on the number of nodes for performing a type of task. The process receives a request to update the computational model for the number of nodes in the computer system (step 402).

The process collects a set of first increment data for the number of nodes (step 404). In this step, the set of first increment data is data that becomes available after the number of model sets are deployed on the number of nodes. The process identifies a subset of sub-models based on the set of first increment data (step 406). The process updates the computational model based on the number of updated models (step 408). The process synchronizes sub-models in different nodes based on the number of updated models (step 410). The process terminates thereafter.

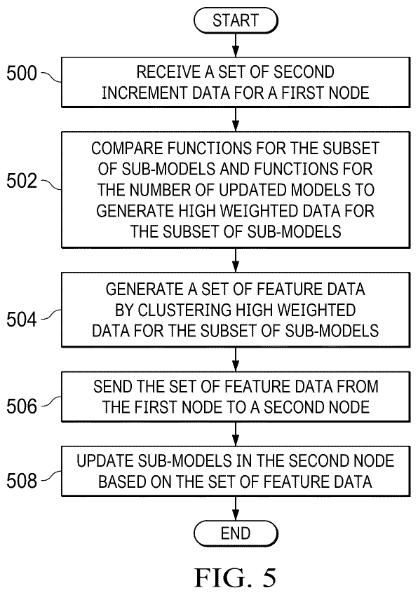

With reference now to FIG. 5, a flowchart illustrating a process for synchronizing sub-models in different nodes based on the number of updated models is shown in accordance with an illustrative embodiment. The process in this flowchart is an example of an implementation for step 410 in FIG. 4.

The process begins by receiving a set of second increment data for a first node (step 500). In this step, the set of second increment data is selected during the update of the computational model. The process compares functions for the subset of sub-models and functions for the number of updated models to generate high weighted data for the subset of sub-models (step 502).

The process generates a set of feature data by clustering high weighted data for the subset of sub-models (step 504). The process sends the set of feature data from the first node to a second node (step 506). The process updates sub-models in the second node based on the set of feature data (step 508). The process terminates thereafter.

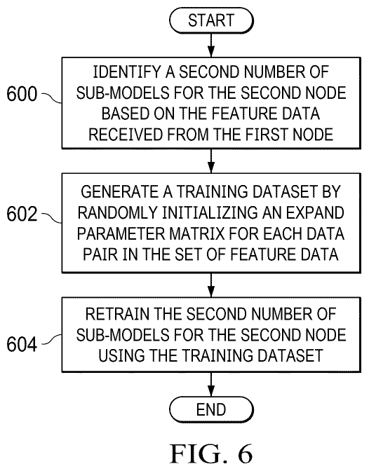

With reference now to FIG. 6, a flowchart illustrating a process for retraining the second number of sub-models for the second node using the training dataset is shown in accordance with an illustrative embodiment. The process in this flowchart is an example of an implementation for step 508 in FIG. 5.

The process begins by identifying a second number of sub-models for the second node based on the feature data received from the first node (step 600). The process generates a training dataset by randomly initializing an expand parameter matrix for each data pair in the set of feature data (step 602). The process retrains the second number of sub-models for the second node using the training dataset (step 604). The process terminates thereafter.

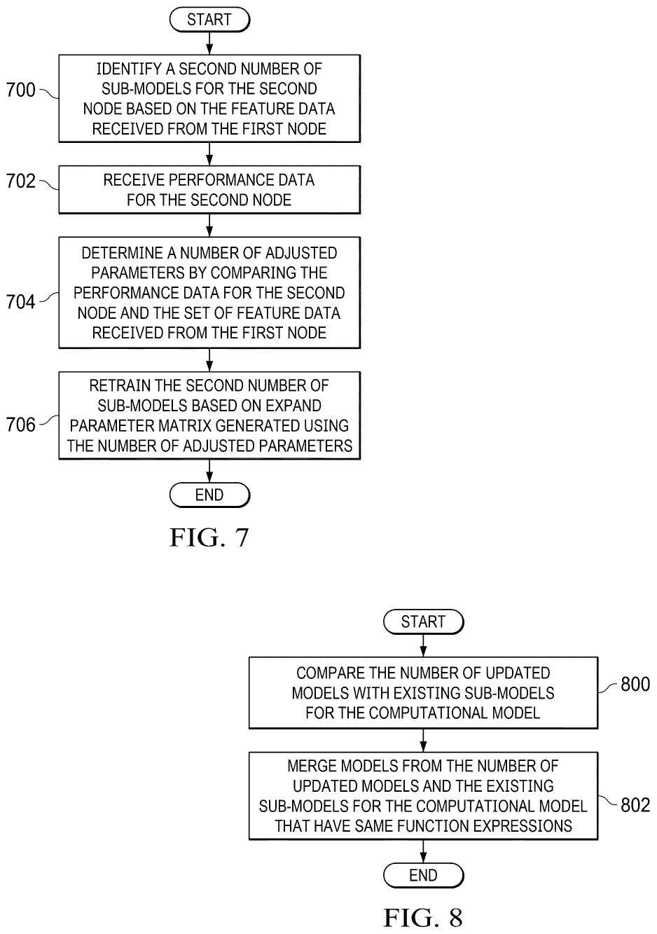

With reference now to FIG. 7, a flowchart illustrating a process for updating sub-models in the second node based on the set of feature data is shown in accordance with an illustrative embodiment. The process in this flowchart is an example of an implementation for step 508 in FIG. 5.

The process begins by identifying a second number of sub-models for the second node based on the set of feature data received from the first node (step 700). The process receives performance data for the second node (step 702). The process determines a number of adjusted parameters by comparing the performance data for the second node and the set of feature data received from the first node (step 704). The process retrains the second number of sub-models based on the expand parameter matrix generated using the number of adjusted parameters (step 706). The process terminates thereafter.

With reference now to FIG. 8, a flowchart illustrating a process for updating the computational model based on the number of updated models is shown in accordance with an illustrative embodiment. The process in this flowchart is an example of an implementation for step 508 in FIG. 5.

The process begins by comparing the number of updated models with existing sub-models for the computational model (step 800). The process merges models from the number of updated models and the existing sub-models for the computational model that have same function expressions (step 802). The process terminates thereafter.

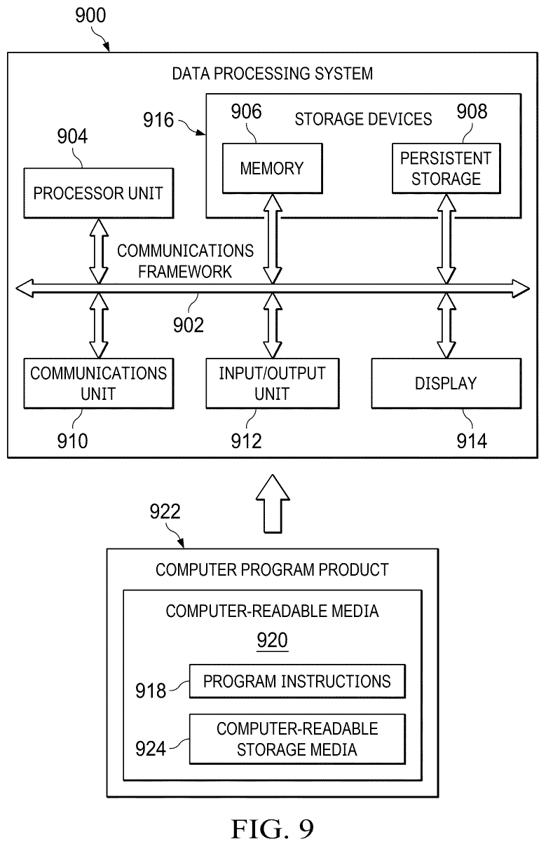

Turning now to FIG. 9, a block diagram of a data processing system is depicted in accordance with an illustrative embodiment. Data processing system 900 can be used to implement computers and computing devices in computing environment 100 in FIG. 1. Data processing system 900 can also be used to implement computer system 204 in FIG. 2. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are referred to as program instructions, computer usable program instructions, or computer-readable program instructions that can be read and executed by a processor in processor unit 904. The program instructions in the different embodiments can be embodied on different physical or computer-readable storage media, such as memory 906 or persistent storage 908.

Program instructions 918 are located in a functional form on computer-readable media 920 that is selectively removable and can be loaded onto or transferred to data processing system 900 for execution by processor unit 904. Program instructions 918 and computer-readable media 920 form computer program product 922 in these illustrative examples. In the illustrative example, computer-readable media 920 is computer-readable storage media 924.

Computer-readable storage media 924 is a physical or tangible storage device used to store program instructions 918 rather than a medium that propagates or transmits program instructions 918. Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 918 can be transferred to data processing system 900 using a computer-readable signal media. The computer-readable signal media are signals and can be, for example, a propagated data signal containing program instructions 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 920” can be singular or plural. For example, program instructions 918 can be located in computer-readable media 920 in the form of a single storage device or system. In another example, program instructions 918 can be located in computer-readable media 920 that is distributed in multiple data processing systems. In other words, some instructions in program instructions 918 can be located in one data processing system while other instructions in program instructions 918 can be located in one data processing system. For example, a portion of program instructions 918 can be located in computer-readable media 920 in a server computer while another portion of program instructions 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for synchronizing computational models across different nodes in a computer system, the computer implemented method comprising:
splitting, by a processor set, a computational model to generate a number of model sets for a number of nodes in the computer system, wherein each model set from the number of model sets comprises a number of sub-models running on the number of nodes for performing a type of task;
receiving, by the processor set, a request to update the computational model for the number of nodes in the computer system;
collecting, by the processor set, a set of first increment data for the number of nodes, wherein the set of first increment data is data that becomes available after the number of model sets are deployed on the number of nodes;
identifying, by the processor set, a subset of sub-models based on the set of first increment data, wherein the subset of sub-models is retrained to generate a number of updated models using the set of first increment data as training data;
updating, by the processor set, the computational model based on the number of updated models; and
synchronizing, by the processor set, sub-models in different nodes based on the number of updated models.

2. The computer implemented method of claim 1, wherein synchronizing, by the processor set, sub-models in different nodes based on the number of updated models comprises:
receiving, by the processor set, a set of second increment data for a first node, wherein the set of second increment data is selected during the update of the computational model;
comparing, by the processor set, functions for the subset of sub-models and functions for the number of updated models to generate high weighted data for the subset of sub-models;
generating, by the processor set, a set of feature data by clustering high weighted data for the subset of sub-models;
sending, by the processor set, the set of feature data from the first node to a second node; and
updating, by the processor set, sub-models in the second node based on the set of feature data.

3. The computer implemented method of claim 2, wherein updating, by the processor set, sub-models in the second node based on the set of feature data comprises:
identifying, by the processor set, a second number of sub-models for the second node based on the set of feature data received from the first node;
generating, by the processor set, a training dataset by randomly initializing an expand parameter matrix for each data pair in the set of feature data; and
retraining, by the processor set, the second number of sub-models for the second node using the training dataset.

4. The computer implemented method of claim 2, wherein the high weighted data comprises the largest weight for a number of parameters in functions for the subset of sub-models and functions for the number of updated models.

5. The computer implemented method of claim 2, wherein updating, by the processor set, sub-models in the second node based on the set of feature data comprises:
identifying, by the processor set, a second number of sub-models for the second node based on the set of feature data received from the first node;
receiving, by the processor set, performance data for the second node;
determining, by the processor set, a number of adjusted parameters by comparing the performance data for the second node and the set of feature data received from the first node; and
retraining, by the processor set, the second number of sub-models based on expand parameter matrix generated using the number of adjusted parameters.

6. The computer implemented method of claim 1, wherein updating, by the processor set, the computational model based on the number of updated models comprises:
comparing, by the processor set, the number of updated models with existing sub-models for the computational model; and
merging, by the processor set, models from the number of updated models and the existing sub-models for the computational model that have same function expressions.

7. The computer implemented method of claim 6, wherein the comparison between the number of updated models with existing sub-models for the computational model is performed by analyzing transactions for the computational model, rate of each transaction for the computational model, and system cost for the computational model.

8. A computer system for synchronizing computational models across different nodes in a computer system, comprising:
a processor set;
a set of one or more computer-readable storage media; and
program instructions stored on the set of one or more storage media to cause the processor set to perform operations comprising:
splitting a computational model to generate a number of model sets for a number of nodes in the computer system, wherein each model set from the number of model sets comprises a number of sub-models running on the number of nodes for performing a type of task;
receiving a request to update the computational model for the number of nodes in the computer system;
collecting a set of first increment data for the number of nodes, wherein the set of first increment data is data that becomes available after the number of model sets are deployed on the number of nodes;
identifying a subset of sub-models based on the set of first increment data, wherein the subset of sub-models is retrained to generate a number of updated models using the set of first increment data as training data;
updating the computational model based on the number of updated models; and
synchronizing sub-models in different nodes based on the number of updated models.

9. The computer system of claim 8, wherein synchronizing, by the processor set, sub-models in different nodes based on the number of updated models comprises:
receiving a set of second increment data for a first node, wherein the set of second increment data is selected during the update of the computational model;
comparing functions for the subset of sub-models and functions for the number of updated models to generate high weighted data for the subset of sub-models;
generating a set of feature data by clustering high weighted data for the subset of sub-models;
sending the set of feature data from the first node to a second node; and
updating sub-models in the second node based on the set of feature data.

10. The computer system of claim 9, wherein updating sub-models in the second node based on the set of feature data comprises:
identifying a second number of sub-models for the second node based on the set of feature data received from the first node;
generating a training dataset by randomly initializing an expand parameter matrix for each data pair in the set of feature data; and
retraining the second number of sub-models for the second node using the training dataset.

11. The computer system of claim 9, wherein the high weighted data comprises the largest weight for a number of parameters in functions for the subset of sub-models and functions for the number of updated models.

12. The computer system of claim 9, wherein updating sub-models in the second node based on the set of feature data comprises:
identifying a second number of sub-models for the second node based on the set of feature data received from the first node;
receiving performance data for the second node;
determining a number of adjusted parameters by comparing the performance data for the second node and the set of feature data received from the first node; and
retraining the second number of sub-models based on expand parameter matrix generated using the number of adjusted parameters.

13. The computer system of claim 8, wherein updating the computational model based on the number of updated models comprises:
comparing the number of updated models with existing sub-models for the computational model; and
merging models from the number of updated models and the existing sub-models for the computational model that have same function expressions.

14. The computer system of claim 13, wherein the comparison between the number of updated models with existing sub-models for the computational model is performed by analyzing transactions for the computational model, rate of each transaction for the computational model, and system cost for the computational model.

15. A computer program product for synchronizing computational models across different nodes in a computer system, comprising:
a set of one or more computer-readable storage media;
program instructions stored in the set of one or more computer-readable storage media to perform operations comprising:
splitting, by a processor set, a computational model to generate a number of model sets for a number of nodes in the computer system, wherein each model set from the number of model sets comprises a number of sub-models running on the number of nodes for performing a type of task;
receiving, by the processor set, a request to update the computational model for the number of nodes in the computer system;
collecting, by the processor set, a set of first increment data for the number of nodes, wherein the set of first increment data is data that becomes available after the number of model sets are deployed on the number of nodes;
identifying, by the processor set, a subset of sub-models based on the set of first increment data, wherein the subset of sub-models is retrained to generate a number of updated models using the set of first increment data as training data;
updating, by the processor set, the computational model based on the number of updated models; and
synchronizing, by the processor set, sub-models in different nodes based on the number of updated models.

16. The computer program product of claim 15, wherein synchronizing, by the processor set, sub-models in different nodes based on the number of updated models comprises:
receiving, by the processor set, a set of second increment data for a first node, wherein the set of second increment data is selected during the update of the computational model;
comparing, by the processor set, functions for the subset of sub-models and functions for the number of updated models to generate high weighted data for the subset of sub-models;
generating, by the processor set, a set of feature data by clustering high weighted data for the subset of sub-models;
sending, by the processor set, the set of feature data from the first node to a second node; and
updating, by the processor set, sub-models in the second node based on the set of feature data.

17. The computer program product of claim 16, wherein updating, by the processor set, sub-models in the second node based on the set of feature data comprises:
identifying, by the processor set, a second number of sub-models for the second node based on the set of feature data received from the first node;
generating, by the processor set, a training dataset by randomly initializing an expand parameter matrix for each data pair in the set of feature data; and
retraining, by the processor set, the second number of sub-models for the second node using the training dataset.

18. The computer program product of claim 17, wherein the high weighted data comprises the largest weight for a number of parameters in functions for the subset of sub-models and functions for the number of updated models.

19. The computer program product of claim 16, wherein updating, by the processor set, sub-models in the second node based on the set of feature data comprises:
identifying, by the processor set, a second number of sub-models for the second node based on the set of feature data received from the first node;
receiving, by the processor set, performance data for the second node;
determining, by the processor set, a number of adjusted parameters by comparing the performance data for the second node and the set of feature data received from the first node; and
retraining, by the processor set, the second number of sub-models based on expand parameter matrix generated using the number of adjusted parameters.

20. The computer program product of claim 15, wherein updating, by the processor set, the computational model based on the number of updated models comprises:
comparing, by the processor set, the number of updated models with existing sub-models for the computational model; and
merging, by the processor set, models from the number of updated models and the existing sub-models for the computational model that have same function expressions.
